(19) United States
(12) Patent Application Publication
(10) Pub. No.: US 2024/0072278 A1
(43) Pub. Date: Feb. 29, 2024

(54) CONVEYING APPARATUS FOR MEDIA

(71) Applicant: CELLCENTRIC GMBH & CO. KG, Kirchheim/Teck-Nabern (DE)

(72) Inventors: Armin MÜTSCHELE, Kirchheim/Teck-Nabern (DE); Harald BADOWSKY, Kirchheim/Teck-Nabern (DE)

(21) Appl. No.: 18/261,208

(22) PCT Filed: Jan. 19, 2022
(86) PCT No.: PCT/EP2022/051152

§ 371 Date: Jul. 12, 2023

(30) Foreign Application Priority Data
Jan. 22, 2021 (DE) 10 2021 000 306.3

(51) Int. Cl. H01M 8/04082; H01M 8/04089

(52) U.S. Cl. CPC H01M 8/04201; H01M 8/04097; H01M 2250/20

(57) ABSTRACT

The invention relates to a conveying apparatus for media in a fuel cell system (1) having a drive machine (21), via which at least one conveying device (8) for air and at least one conveying device (14) for recirculated anode exhaust gas are driven via at least one cooling medium pump (17). The conveying apparatus according to the invention is characterized in that the drive machine (21) includes a rotor shaft (22) to which the cooling medium pump (17) is directly coupled, wherein the cooling medium pump (17) or the drive machine (21) is magnetically coupled to one of the conveying devices (8, 14) and the drive machine (21) or the conveying device (8, 14) is magnetically coupled to the other conveying device (14, 8).

The invention relates to a conveying apparatus for media in a fuel cell system according to the type defined in more detail in the preamble of claim 1. The invention also relates to a fuel cell system having such a conveying apparatus and a vehicle having such a fuel cell system.

Fuel cell systems, for example for use to provide electrical drive power in at least partially electrically driven vehicles, are known from the prior art. In fuel cell systems, it is the case that on the one hand air has to be conveyed as an oxygen supplier and on the other hand a cooling system is required, in which a typically liquid cooling medium is circulated to dissipate waste heat. In addition, a so-called anode circuit is provided in many fuel cells. To compensate for pressure losses, a recirculation fan is often provided alone or in addition to a gas jet pump. In practice, it is now the case that typically both the cooling medium pump and an air conveying device, such as a flow compressor, as well as a recirculation conveying device, such as a recirculation fan, are each equipped with their own drive, typically an electric motor drive. On the one hand, this causes a high demand for installation space and, on the other hand, the need for a large number of electrical supply lines to the individual components.

DE 10 2004 037 141 A1 therefore describes a fuel cell system having units for conveying media, in which there is a common drive for multiple units. The required speeds and delivery rates are matched via appropriate speed step-up and/or step-down devices, i.e. gears, and, if necessary, the individual units are switched on and switched off for the drive by the one drive unit.

In practice, this structure is to be assessed relatively critically, since the required gears, similarly to the direct connection to the drive motors according to the above-mentioned general prior art, often introduce oils into the area of the conveyed air and/or the circulated anode exhaust gas. These are disadvantageous for the fuel cell and promote degradation of the electrochemically active components in the fuel cell, so that there can be disadvantages with regard to the service life to be expected of the fuel cell.

Reference can also be made to DE 10 2004 044 068 A1 for further prior art. This document describes a common drive for two conveying devices for the air to a fuel cell on the one hand and the recirculation of anode exhaust gas on the other hand. In order to prevent these substances from mixing, these devices are connected to the common drive motor in a hermetically sealed manner, in that the structure is implemented in each case in the form of so-called canned motors.

For further prior art, reference can be made to DE 10 2012 008 494 A1, which discloses two cooling medium pumps having a common electric motor drive. In addition, reference can also be made to WO 2010/082913 A1. This discloses multiple electric motor drives combined in a motor housing, which are magnetically coupled to the respective driven conveying units.

The object of the present invention is now to specify an improved conveying apparatus for media in a fuel cell system.

According to the invention, this object is achieved by a conveying apparatus having the features in claim 1. Furthermore, a fuel cell system having such a conveying apparatus achieves the object. A vehicle having a fuel cell system and such a conveying apparatus can also achieve the object.

Further advantageous designs of the conveying apparatus additionally result from the subclaims dependent on the main claim.

Similar to the prior art mentioned at the outset, the conveying apparatus according to the invention uses a common drive machine for a cooling medium pump, a conveying device for air, and a conveying device for anode exhaust gas. The drive machine is directly connected to the cooling medium pump by a rotor shaft of the drive machine. Any lubricants and the like that are required in the area of the drive machine, typically an electric drive machine, are relatively uncritical here, so that the direct connection with a common shaft is advantageous here. In addition to this direct coupling, either the cooling medium pump or the drive machine is now magnetically coupled to one of the conveying devices, and in turn the drive machine or the coupled conveying device is then coupled to the other conveying device using a further magnetic coupling.

In principle, this has the decisive advantage that only a single drive machine is required, preferably an electric drive machine, which may, however, be assisted by a turbine, as is the case with the so-called electric turbocharger, as is generally known and typical in fuel cell systems. This drive machine can now in turn be coupled directly to the cooling medium pump by its driven shaft, for example the rotor shaft of the electric drive motor, and can drive it directly. The two conveying devices for the air and the anode exhaust gas are then coupled via magnetic clutches. These can be coupled one behind the other, for example, so that one of the conveying devices, for example the air conveying device or its compressor wheel, is coupled to the pump via a magnetic clutch and a fan wheel of the recirculation conveying device is in turn coupled to the air conveying device using a magnetic clutch. This has the decisive advantage that undesirable substances from the area of the electrical machine are introduced neither into the air nor the recirculated anode exhaust gas. A comparable structure is of course also possible if one or both of the conveying devices are magnetically coupled to the drive machine and, on the other hand, the cooling medium pump alone or the cooling medium pump and one of the conveying devices are correspondingly coupled.

The magnetic coupling of the conveying device for the air on the one hand and the conveying device for the recirculation of the anode exhaust gas on the other hand has the decisive advantage that the structure having the corresponding media can be sealed very easily and efficiently. In the case of the anode exhaust gas in particular, which contains hydrogen, this is a decisive advantage in order to efficiently prevent hydrogen from escaping into the environment. This is indispensable for safety reasons.

For at least one of the conveying devices, according to an advantageous embodiment of the conveying device, a gear for speed matching is provided in the area of the cooling medium pump and/or one of the conveying devices. It is preferably the case that the gear is arranged on the motor side or in the area of the cooling medium pump and the speed that has already been stepped up is then transmitted via the magnetic clutch to the compressor wheel and/or the fan wheel of the respective conveying device. This structure minimizes contamination with corresponding lubricants, which are provided, for example, in the area of the gear. Depending on the structure of the corresponding conveying device, however, simple non-lubricated gear elements can also be used, for example in the area of the recirculation fan, so that the gear could also be arranged between the magnetic clutch and the recirculation fan itself.

As already mentioned, such a conveying device is particularly suitable for use in fuel cell systems which include at least one cooling medium pump, at least one conveying device for the air, and at least one conveying device for the recirculation of anode exhaust gas. The conveying device can advantageously be used there. In principle, this applies both in stationary fuel cell systems and also in vehicles which are supplied with at least part of their electrical drive power using at least one of these fuel cell systems.

Further advantageous designs of the conveying apparatus, the fuel cell system, and the vehicle according to the invention also result from the exemplary embodiment, which is explained in more detail hereinafter with reference to the figures.

In the figures:

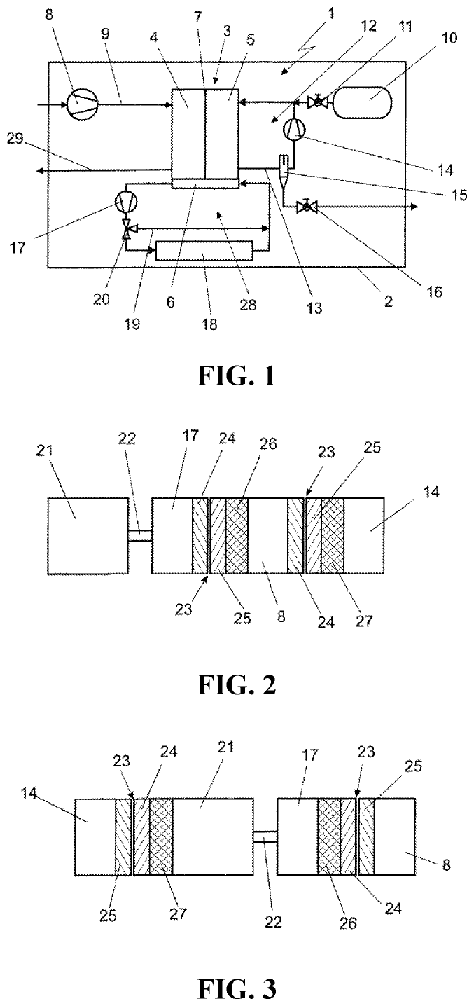

FIG. 1 shows a schematically indicated fuel cell system for use of the conveying apparatus according to the invention;

FIG. 2 shows a first possible embodiment of the conveying apparatus according to the invention in a schematic representation; and

FIG. 3 shows a further alternative embodiment of the conveying apparatus according to the invention in a schematic representation.

In the illustration of FIG. 1, a fuel cell system 1 can be seen, which is intended to be used in a vehicle 2, which is indicated very schematically, to provide at least part of the electrical drive power. Depending on the vehicle 2, multiple such fuel cell systems 1 are provided or one or more fuel cell stacks 3 are provided within the fuel cell system 1 shown here. The one fuel cell stack 3 schematically indicated here comprises a cathode compartment 4, an anode compartment 5, and a cooling heat exchanger 6 indicated as an example in the interior of the fuel cell stack 3. The cathode compartment 4 is separated from the anode compartment 5 by a proton-conducting membrane 7. In reality, this structure is implemented as a stack of individual cells. In the illustration, a common cathode compartment 4 and a common anode compartment as well as a common cooling heat exchanger 6 are indicated schematically solely by way of example.

In order to provide the electrical power through the fuel cell stack 3, air is supplied to it via a supply air line 9 via a conveying device 8. Exhaust air depleted of oxygen arrives via an exhaust air line 29 from the fuel cell system 1 and the vehicle 2. In this area, an exhaust air turbine could be provided in a manner known per se in order to recover pressure energy and thermal energy from the exhaust air. This is insofar known from the prior art and could also be provided here. An illustration has been omitted to simplify FIG. 1.

Hydrogen from a compressed gas storage device 10 is supplied to the cathode chamber 4 via a pressure control and metering valve 11. Unused hydrogen is returned in a so-called anode circuit 12 via a recirculation line 13. Pressure losses are compensated by a conveying device 14 for the recirculated anode exhaust gas. Product water arising in the area of the anode chamber 5 is separated off via a water separator 15. This is discharged via a valve 16 together with inert gases enriched in the anode circuit 12, for example from time to time or depending on the hydrogen concentration in the anode circuit 12.

The cooling heat exchanger 6 of the fuel cell stack 3 is part of a cooling circuit 28 in which a liquid cooling medium is circulated via a cooling medium pump 17. The waste heat is emitted into the surroundings of the vehicle 2 via a cooling heat exchanger, also known colloquially as a cooler. The cooling circuit 28 shown in very simplified form also has a bypass line 19 for bypassing the cooling heat exchanger 18, so that the cooling capacity can be controlled using a valve 20 controlling this bypass line and the speed of the cooling medium pump 17.

All of this is insofar known to a person skilled in the art, so that it does not need to be discussed further.

The cooling medium pump 17 and the two conveying devices 8, 14 are now to be driven via a common drive machine 21. This common drive machine 21 is indicated in the illustration of FIG. 2. This drive machine 21 can be an electric drive machine, for example. It can also be coupled mechanically or electrically with the above-mentioned optimal exhaust air turbine in order to implement a drive that is as energy-efficient as possible. The drive machine 21 is coupled directly to the cooling medium pump 17 via a shaft 22. The cooling medium pump 17 itself or its pump wheel is then coupled via a magnetic clutch 23 having a drive side 24 and an output side 25 to the conveying device 8 for the air. In addition, an optional gear 26 shown cross-hatched can be provided between the output side 25 of the magnetic clutch 23 and the conveying device 8. The conveying device 8 for the air is in turn coupled via a further magnetic clutch 23, again having a drive side 24 and an output side 25, to the conveying device 14 for the recirculated anode exhaust gas. A further gear 27 can also be provided here between the output side 25 of the second magnetic coupling 23 and the conveying device 14 or its fan wheel.

The primary introduction of lubricants occurs in the area in which the shaft 22 directly connects the drive machine 21 and the cooling medium pump 17. This introduction is typically harmless for the cooling medium. On the other hand, the introduction of lubricants into the air and above all into the recirculated exhaust gas is critical, since this could enter the anode compartment 5 or the cathode compartment 4 and adversely influence the electrochemical properties of the fuel cell stack 3 there. For this reason, the two magnetic clutches 23 can be used to decouple these conveying devices 8, 14 from the drive machine 21 relatively well and in a manner which can be easily sealed. Although the optional gears 26, 27 can exacerbate the situation again, gears with only minimal or no lubrication are often required in this area, so that this remains relatively uncritical.

In the illustration of FIG. 3, an alternative embodiment variant is shown. The electric drive machine 21 is again coupled directly to the cooling medium pump 17 via its shaft 22. This is then correspondingly coupled via the optional gear 26, which this time is arranged on the side of the cooling medium pump 17, using one of the magnetic clutches 23 to the conveying device 8 for the air. Possible contamination with lubricant inside the gear 26 can thus be kept away from the air compressed via the conveying device 8 since the magnetic coupling, which is to be sealed very well, takes place via the magnetic clutch 23 between the gear and the compressor wheel of the conveying device 8.

The further conveying device 14 now does not adjoin the compressor wheel of the conveying device 8 but is arranged on the other side of the drive motor 21. It is also the case here that the optional gear 27 is arranged on the motor side and only then does the magnetic clutch 23 follow, so that possible contamination from the electric drive machine 21 and the optional gear can also be prevented from being introduced into the area of the fan wheel of the conveying device 14.

This construction having a sequence of optional gear 26, 27 and magnetic clutch 23 that is reversed in comparison to the illustration in FIG. 2 would of course also be conceivable in the illustration of FIG. 2. It would also be conceivable to use the sequence shown in FIG. 2 in the structure according to FIG. 3. In addition, it would of course be conceivable to exchange the two conveying devices 8, 14 for one another or to attach both on one side of the electric drive machine 21 and the cooling medium pump 17 on the other side of the drive machine 21.

What is claimed is:

1. A conveying apparatus for media in a fuel cell system having a drive machine, via which at least one conveying device for air and at least one conveying device for recirculated anode exhaust gas are driven via at least one cooling medium pump,
wherein
the drive machine includes a rotor shaft to which the cooling medium pump is directly coupled, wherein the cooling medium pump or the drive machine is magnetically coupled to one of the conveying devices and the drive machine or the conveying device is magnetically coupled to the other conveying device.

2. The conveying apparatus as claimed in claim 1,
wherein
the conveying device for the air is designed as a flow compressor.

3. The conveying apparatus as claimed in claim 1,
wherein
the conveying device for the recirculation of anode exhaust gas is designed as a recirculation fan.

4. The conveying apparatus as claimed in claim 1,
wherein
a gear for speed matching is provided in the area of at least one of the conveying devices.

5. The conveying device as claimed in claim 4,
wherein
the gear is provided on the side of the magnetic clutch facing away from the respective conveying device.

6. A fuel cell system having a conveying apparatus as claimed in claim 1.

7. A vehicle having at least one fuel cell system as claimed in claim 6.

8. The conveying apparatus as claimed in claim 1,
wherein
the conveying device for the recirculation of anode exhaust gas is designed as a recirculation fan.

9. The conveying apparatus as claimed in claim 2,
wherein
a gear for speed matching is provided in the area of at least one of the conveying devices.

10. The conveying apparatus as claimed in claim 3,
wherein
a gear for speed matching is provided in the area of at least one of the conveying devices.

11. A fuel cell system having a conveying apparatus as claimed in claim 2.

12. A fuel cell system having a conveying apparatus as claimed in claim 3.

13. A fuel cell system having a conveying apparatus as claimed in claim 4.

14. A fuel cell system having a conveying apparatus as claimed in claim 5.
